(19) United States
(12) Patent Application Publication
(10) Pub. No.: US 2002/0151223 A1
(43) Pub. Date: Oct. 17, 2002

(54) Electric plug

(76) Inventor: Bo Strandfelt, Upplands Vasby (SE)

Correspondence Address: BIRCH STEWART KOLASCH & BIRCH, PO BOX 747, FALLS CHURCH, VA, 22040-0747, US

(21) Appl. No.: 10/102,950

(22) Filed: Mar. 22, 2002

(30) Foreign Application Priority Data
Mar. 28, 2001 (SE) 0101100-6

(51) Int. Cl. H01R 24/04

(52) U.S. Cl. 439/668

(57) ABSTRACT

An electric plug has a pole including a contact rod having a forward end and a rear end, a connector member and spring means interposed between said contact rod and said connector member to urge said contact rod in a forward direction. The contact rod is provided in its rear end with an axial extension and the connector member is provided with a bore slidingly receiving a rear free end of the extension.

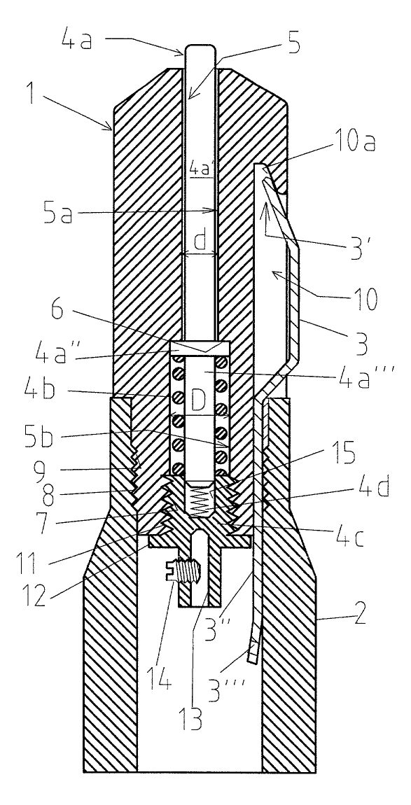

### FIELD OF THE INVENTION

The present invention concerns an electric plug, particularly of the kind to be used in a cigarette lighter socket as used in automobiles etc.

### BACKGROUND OF THE INVENTION

Such plugs include a peripheral pole (normally minus or ground) and a central pole (normally plus). The peripheral pole is generally a metal wire or strip extending along a substantial portion of the plug length, thereby obtaining a relatively long contact length with the interior of the socket. The central pole is generally a cylindrical contact rod that is spring loaded in order to maintain contact with a plus bottom pole of the socket even in case of smaller axial displacements of the plug. The spring load is generally provided by a compression spring, such as a leaf spring or a helical spring. In use, the electrical current is lead through the spring to a connector member that in turn is connected to an electric lead. This is not a problem in low current applications, such as normal flashlights, radio equipment, tape recorders etc., but when it comes to high current applications, such as winches or powerful flashlights, the current load may lead to overheating of the spring such that it loses its spring properties, or, even melts and breaks the electric circuit.

### SUMMARY OF THE INVENTION

The present invention has as its object to provide a new male plug that does not suffer from this drawback. According to the present invention, there is provided an electric plug having a pole including a contact rod having a forward end and a rear end, a connector member and spring means interposed between said contact rod and said connector member to urge said contact rod in a forward direction, wherein said contact rod is provided in its rear end with an axial extension and said connector member is provided with a bore slidingly receiving a rear free end of said extension.

Further scope of applicability of the present invention will become apparent from the detailed description given hereinafter. However, it should be understood that the detailed description and specific example, while indicating a preferred embodiment of the invention, is given by way of example only, since various changes and modifications within the spirit and scope of the invention will become apparent to those skilled in the art from this detailed description.

### BRIEF DESCRIPTION OF THE DRAWING

The sole FIGURE of the accompanying drawing shows a longitudinal section through a plug according to the present invention.

### DESCRIPTION OF A PREFERRED EMBODIMENT

The plug consists of a core portion 1 of insulating material, a handle portion 2 of insulating material, a peripheral pole 3 and a central pole 4.

The core portion has a central bore 5 having a first, relatively small diameter d in a forward portion 5a thereof, and a second, relatively large diameter D in a rear portion 5b thereof. A shoulder 6 is formed between the bore portions 5a and 5b. An internal thread 7 is provided in the rearmost end of the rear bore portion 5b. In its rear end, the core portion has a reduced diameter, and an external thread 8 is provided in the rear end thereof.

The handle portion 2 has an annular cross section and an internal thread 9 in its forward end mating the thread 8.

The peripheral pole 3 is a wire or strip of metal partly located in a recess 10 axially extending along a portion of the periphery of the core portion 1. A forward end 3′ of the pole 3 is located in an undercut forward end 10a of the recess 10, whereas a central portion 10b thereof is bent so as to protrude somewhat exteriorly of the periphery of the core portion 1. A rear end 3″ of the pole 3 extends along the periphery of the core portion and is kept in place by the handle portion 2 when threaded onto the threads 8. A hole 3′″ is provided in the extreme and of the pole 3. The hole may be threaded to receive a non-shown fastening screw for an electric wire, or it may be smooth to receive a wire to be soldered thereto.

The central pole 4 includes a cylindrical metal rod 4a, a spring 4b and a connector member 4c. The spring is shown here to be a helical spring.

The metal rod 4a is axially slidable within the bore 2 of the core portion 1. It has a forward portion 4a′ having a slightly less diameter than the diameter d₁ of the bore portion 5a. The forward portion 4a′ is terminated by a collar 4a″ having a diameter slightly less than the diameter d₂ of the bore portion 5b.

The helical spring 4b has an outer diameter slightly less than the diameter d₂ of the bore portion 5b. A forward end of the spring abuts the collar 4a″, and a rear end thereof abuts the connector member 4c.

The connector member 4c is a metal body having a forward end having external threads 11 mating with the internal threads 7 of the core portion 1, a flange portion 12 and a rear end having a central bore 13 for receiving an electric wire (not shown). A stop screw 14 is threaded through the wall of the connector member to keep the electric wire electrically and mechanically connected thereto.

When screwed into the threads 7, the connector member 4c partly compresses the helical spring 4b so as to resiliently press the flange portion 4a″ against the shoulder 6 and to allow further compression thereof upon an axial force against the free end of the metal rod 4a.

As so far described, the plug substantially corresponds to a state-of-art plug, where a major portion of the current through the plug is transferred through the spring and causes the problems discussed above.

To solve that problem, the present invention provides a rear portion or extension 4a′″ of the metal rod 4a that may have substantially the same diameter as its forward portion 4a′. In its partly compressed state shown, the helical spring 4b encloses the extension 4a′″ and a free, rear end of the latter extends into a bore 15 provided in the connector member 4c so as to allow relative sliding motion therebetween, still maintaining a good electrical contact between the extension and the connector member.

As a consequence, the helical spring does not have to transfer current through the plug alone any more, since the metal rod 4a is a continuous bar extending into the connector member 4c. In use, the metal rod 4a is likely to be further pressed into the connector member 4c, thereby providing an increased contact area between its free end and the bore 15. Naturally, still a portion of the current will be lead through the helical spring abutting the flange 6, at least randomly contacting portions of the metal rod extension 4a′″, and contacting the forward end of the connector member 4c.

As an alternative to, or, a complement to, what has been described above, a compression spring 4d may be located within the bore 15 to be supported by the bottom of the bore and the free end of the extension 4a″ as shown. Like in the case of the helical spring 4b, electrical current is transferred from the metal rod 4a′, through its extension 4″ and into the connector member 4c as well as through the spring 4d.

The invention being thus described, it will be obvious that the same may be varied in many ways. Such variations are not to be regarded as departure from the spirit and scope of the invention, and all such modifications as would be obvious to one skilled in the art were intended to be included withi8n the scope of the following claims.

1. An electric plug having a pole including a contact rod having a forward end and a rear end, a connector member and spring means interposed between said contact rod and said connector member to urge said contact rod in a forward direction, wherein said contact rod is provided in its rear end with an axial extension and said connector member is provided with a bore slidingly receiving a rear free end of said extension.

2. The plug according to claim 1, wherein said spring means is a helical first spring completely surrounding said extension.

3. The plug according to claim 1, wherein a second spring is located in said bore to support said rear free end of said extension.

4. The plug according to claim 1, wherein a helical first spring completely surrounds said extension and a second spring is located in said bore to support said rear free end of said extension.

5. The plug according to claim 2, wherein a radial flange is provided in said rear end of said contact rod, said radial flange constituting a support for said helical first spring.

6. The plug according to claim 4, wherein a radial flange is provided in said rear end of said contact rod, said radial flange constituting a support for said helical first spring.

7. The plug according to claim 5, including a housing having a bore slidingly receiving said contact rod, said radial flange constituting an abutment limiting movement of said contact rod in said forward direction.

8. The plug according to claim 6, including a housing having a bore slidingly receiving said contact rod, said radial flange constituting an abutment limiting movement of said contact rod in said forward direction.

9. The plug according to claim 1, wherein said free end of said extension and said bore of said connector member are dimensioned to provide mutual sliding electrical contact.
